(19) United States
(12) Patent Application Publication
(10) Pub. No.: US 2025/0289017 A1
(43) Pub. Date: Sep. 18, 2025

(54) Spray Gun Trigger, Spray Gun Comprising Said Trigger and Safety Lock for Said Trigger

(71) Applicant: P.A. SPA., Rubiera (RE) (IT)

(72) Inventor: Arnaldo BENETTI, Rubiera (RE) (IT)

(73) Assignee: P.A. SPA., Rubiera (RE) (IT)

(21) Appl. No.: 19/053,442

(22) Filed: Feb. 14, 2025

(30) Foreign Application Priority Data
Mar. 12, 2024 (IT) 10202400005443

(51) Int. Cl. B05B 12/00; B05B 9/01

(52) U.S. Cl. CPC B05B 12/0022; B05B 9/01

(57) ABSTRACT

A trigger (5) for a spray gun (1) comprising a main body (51), configured to move between a rest position and a working position; a safety lock (6), hinged on said main body (51) and rotating with respect thereto between a lock position, in which it prevents the movement of the main body (51) from the rest position toward the working position, and an unlock position, in which it allows the movement of the main body toward the working position; and elastic return means configured to define an elastic return action that biases said safety lock (6) toward the lock position, said elastic return means being made integral with said main body (51) and/or with said safety lock (6).

### FIELD OF APPLICATION

The present invention refers to a trigger for spray gun and to a safety lock for said trigger and generally to a spray gun.

In particular, the trigger according to the present invention finds useful application in sectors where it is required to ensure the safety of operators when the trigger is released.

The sectors concerning the present invention are the mining sector, including the use of hydro-excavators; the cleaning sector with the use of high-pressure cleaners; or more generally all sectors that use pressurized fluid supply guns, in particular where the pressure is sufficiently high to be able to cause a danger to users, if they are not protected by the presence of suitable safety devices.

### PRIOR ART

As well known, in the previously identified technical sectors and in others, the use of guns for supplying fluids is required, in some cases at relatively high pressure and such as to be potentially dangerous for the operators.

In order to avoid injuries due to the involuntary activation of the supply gun, said devices are generally equipped with a safety lock-more simply called a safety-which allows the gun trigger to be locked in the rest position. Said safety is generally made in the form of a rigid hinged tab close to the free end of the trigger. In an unlock position, said tab is placed close to the trigger and therefore allows it to be pressed toward the handle; in a lock position, the same tab is instead extracted and acts as a strut, preventing the trigger from approaching the handle.

While meeting the main safety requirements, said systems nevertheless present a drawback related to the need to manually insert the aforementioned safety. The so-called “dead man” safety is therefore not guaranteed, that is, the safety is not automatically inserted if the user inadvertently releases the trigger, for example due to sudden illness. Given the fortunately increasingly stringent safety standards, this drawback, once neglected, today becomes more critical especially in higher-risk applications, for example in the mining sector where high pressures are applied in sometimes difficult environmental conditions.

On the other hand, the development of a self-inserting safety lock required a redesign of spray guns, making the design of the trigger equipped with safety more complex and more costly. In particular, the trigger assembly comprising the safety was modified by inserting additional elements such as torsion springs, also requiring a modification of the plastic molded components for housing them.

It should also be emphasized that the use of the torsion spring introduces a criticality in the operation of the device, given that this element can be damaged or can come out of its seat.

Furthermore, it should be emphasized that replacing the guns currently in use with others equipped with an automatically insertable safety would require substantial conversion costs in certain industries.

### SUMMARY

The technical problem underlying the present invention is therefore to devise a reliable and low-cost automatically insertable safety system for a spray gun.

A further object of the present invention is to allow an easy and economical replacement of the dead man's safety system even on guns of the prior art, which did not provide this safety.

The idea underlying the present invention is to ensure the automatic insertion of the safety system by means of a yielding mechanism integrated into the safety or into the trigger in which it is integrated.

The technical problem identified above is therefore solved by a trigger for spray gun comprising a main body, configured to move between a rest position and a working position; a safety lock, hinged on said main body and rotating with respect thereto between a lock position, in which it prevents the movement of the main body from the rest position toward the working position, and an unlock position, in which it allows the movement of the main body toward the working position; and elastic return means configured to define an elastic return action that biases said safety lock toward the lock position, said elastic return means being made integral with said main body and/or with said safety lock.

Preferably, as mentioned above, said elastic return means are defined by a yielding mechanism integrated into the main body and/or into the safety lock.

It is easy to understand how the abovementioned embodiment is reliable and economical to produce, since it does not involve the use of springs or other inserted elastic elements but requires only the production of the main body and the safety lock.

Preferably, main body and safety lock are made of plastic material, for example by injection molding.

The main body is preferably a driving lever but can have another shape, for example it can be a presser that can be driven in translation with respect to the gun body.

Preferably, said main body and said safety lock comprise a first interference profile and a second interference profile, respectively, said first and second interference profiles progressively interfering with each other during the movement of the safety lock from the lock position to the unlock position so as to elastically deform the elastic return means.

Preferably, at least one of said first and said second interference profiles comprises a ramp tilted with respect to a plane orthogonal to a hinge axis of the safety lock.

Preferably, said elastic return means are made integral with said safety lock, said safety lock develops from a hinged end to a free end and is U-shaped, with two elastically deformable arms connected by a bridge at said free end, said elastic return means comprising at least said arms.

Preferably, said first interference profile is defined by outer lateral surfaces of a rib of the main body projecting in the direction of the safety lock, said second interference profile being defined by inner lateral surfaces of said arms.

Preferably, said second interference profile is defined by ramps tilted with respect to a plane orthogonal to the rotation axis of an angle comprised between 0.5° and 30°.

Preferably, the hinging of said safety lock on said main body is made by means of two opposite pins inserted in respective holes, said pins and said holes being obtained on said arms and on said main body, respectively, or vice versa. In particular, the holes can be defined by the opposing ends of a through hole.

Preferably, said safety lock develops from a hinged end to a free end, an edge of said free end opposite the main body being rounded, in order to facilitate the closing of the safety lock when the trigger is activated.

The technical problem previously identified is also solved by a spray gun, in particular for high-pressure cleaning and/or hydro-excavation, comprising a body equipped with a handle and a trigger of the type described above, said trigger being movable between a rest position, in which it closes a liquid supply valve inside the body, and a working position in which it opens said liquid supply valve.

The technical problem identified above is also solved by a safety lock for trigger of spray gun, configured to hinge on a main body of a spray gun trigger rotatably with respect thereto between a lock position, in which it prevents the movement of said main body from a rest position toward a working position, and an unlock position, in which it allows the movement of the main body toward the working position; said safety lock comprises elastic return means, made integral therewith, configured to define an elastic return action that biases it toward the lock position.

The integration of the yielding mechanism on the safety lock, employing the geometry of the current driving levers in order to deform said mechanism in the unlock position, advantageously allows existing guns to be adapted only by quickly and economically replacing the safety lock.

### BRIEF DESCRIPTION OF THE DRAWINGS

FIG. 1 shows a schematical view of a spray gun according to the present invention with the trigger in the rest position;

FIG. 2 shows a schematical view of the gun of FIG. 1 with the trigger in the working position;

FIGS. 3a-3d show schematical lateral view of a trigger with a respective safety lock, progressively illustrated from a lock position to an unlock position;

FIGS. 4a-4d show transversal sections of the respective lateral views 3a-3d according to the section planes A-A, B-B, C-C, D-D;

FIG. 5 shows a view from above of the safety lock of the spray gun according to the present invention;

FIG. 6 shows a sectional view of the safety lock, along the transversal plane A-A of FIG. 5;

FIG. 7 shows a prospective view of the safety lock of FIG. 5.

### DETAILED DESCRIPTION

It is firstly pointed out that the figures represent schematic views and are not drawn to scale but so as to emphasize the most important aspects and features of this disclosure. Also the shapes of the various elements composing the high-pressure cleaning gun are not to be understood in a binding sense.

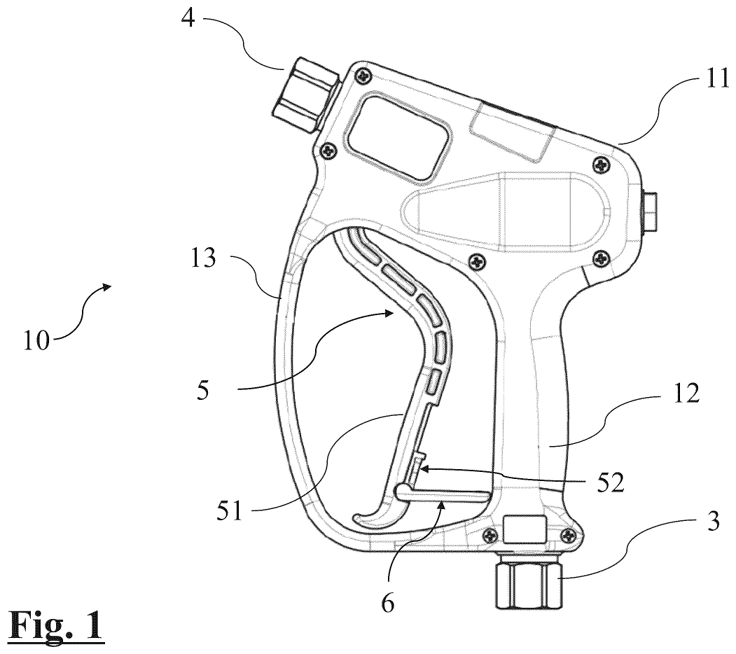

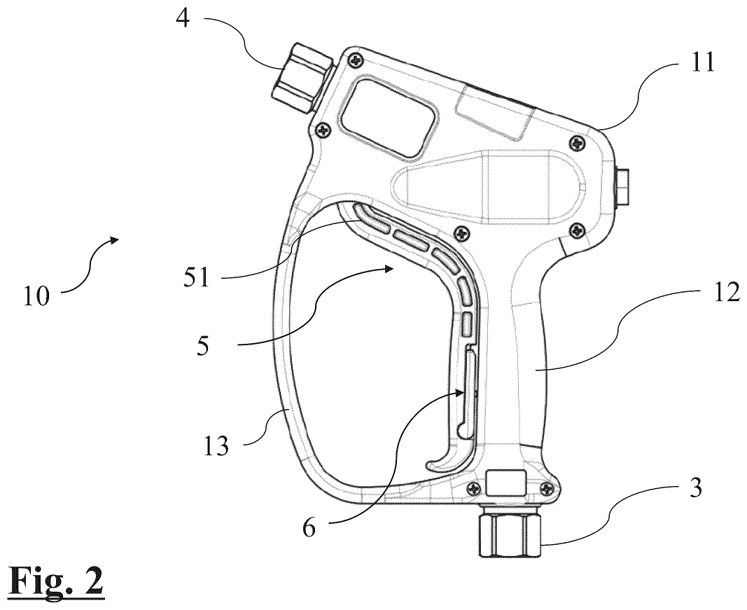

In FIGS. 1 and 2, a spray gun according to the present invention is identified by 10, in particular a gun for high-pressure cleaning or hydro-excavation.

Said spray gun 10 comprises a body 11 equipped with a liquid inlet 3 and a liquid outlet 4. In a manner known per se, both said liquid inlet 3 and said liquid outlet 4 are equipped with connectors for connecting the spray gun 10 to other components of a pressurized liquid supply system, for example a high-pressure cleaner or a hydro-excavator. Specifically, a supply tube, possibly tested to be used even under pressure, can be hydraulically connected to the liquid inlet 3 while a terminal lance can be hydraulically connected to the liquid outlet 4. For convenience, both said lance and said supply tube are not visible in the figures as they do not represent the object of the present invention.

Inside said body 11, a liquid path is made between the liquid inlet 3 and the liquid outlet 4 intercepted by a liquid supply valve. The liquid supply valve is controlled by a trigger 5 movable between a rest position, represented in FIG. 1, and a working position, visible in FIG. 2.

In the preferred embodiment described herein, the body 11 comprises a handle 12 that defines an overall inverted L-shape, at the opposite ends of which the liquid inlet 3 and the liquid outlet 4 are present. The two opposite ends of the L are joined at the bottom by a handguard fitting 12 that encloses a slot within which the trigger 5 moves. In alternative embodiments, the body may be differently shaped, for example having the liquid inlet 3 and the liquid outlet 4 substantially aligned along the direction of the handle 12.

Said trigger 5 comprises a main body 51 directly connected to the control valve. In the illustrated embodiment, the main body 51 is represented by a shaped lever hinged to the body 11 at a first hinge axis x, located close to the liquid outlet 4. The main body 51 can therefore rotate in a sliding plane orthogonal to the first hinge axis x, moving between the aforementioned rest and working positions.

As visible in FIG. 1, in the rest position, the main body 51 of the trigger 5 is in a distanced relation with respect to the handle 12 of the spray gun 10.

As instead visible in FIG. 2, in the working position the trigger 5 is placed close to the handle 12 of the spray gun 10.

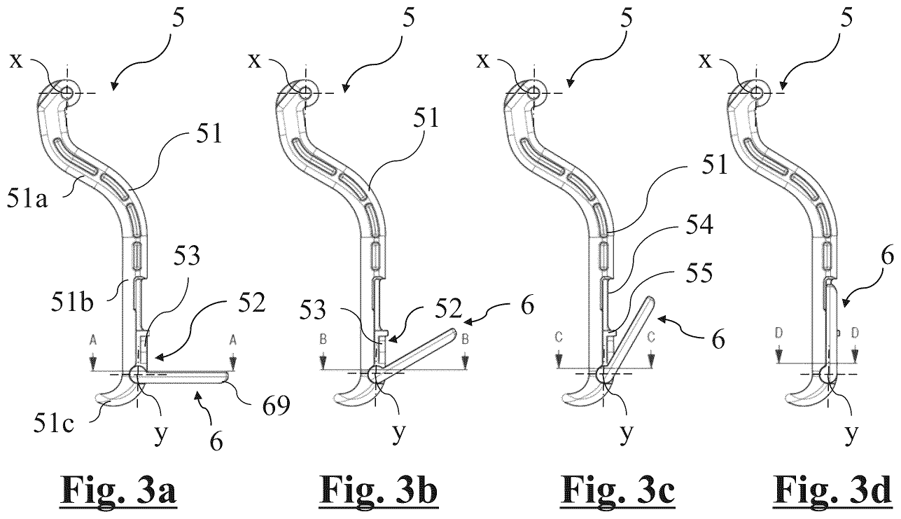

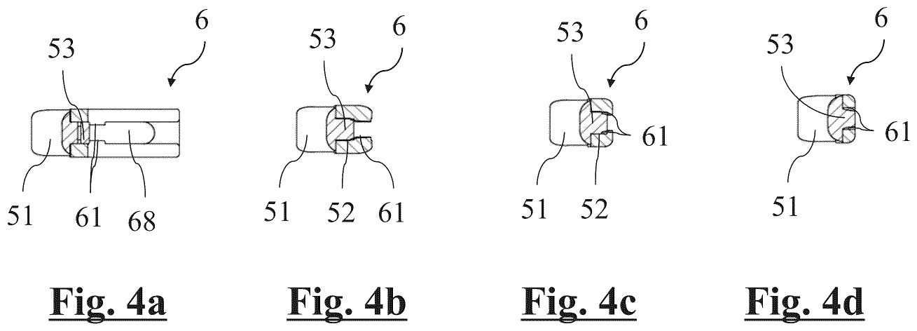

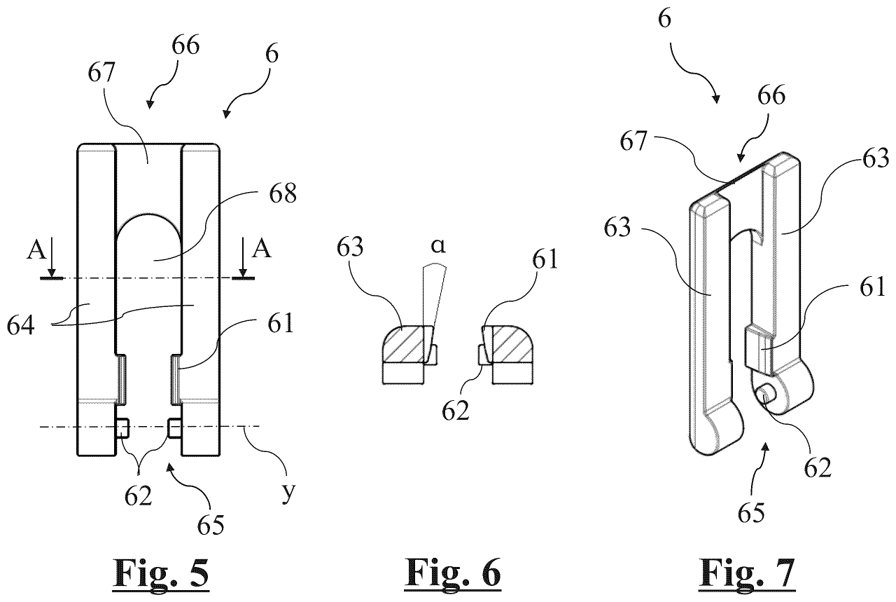

In the embodiment illustrated in FIGS. 3a-3d, the main body 51 comprises a first curvilinear portion 51a, which develops from the hinged end tilting toward the handle 12, followed by an intermediate rectilinear portion 51b and a free end portion 51c which curves away from the handle 12.

Said trigger 5 comprises a safety lock 6 hinged to the main body at a second hinge axis y, placed at the transition point between the rectilinear intermediate portion 51b and the free end portion 51c.

The safety lock 6 is thus able to rotate between a lock position, which is visible for example in FIG. 3a, in which it extends in a direction substantially orthogonal with respect to the rectilinear intermediate portion 51b of the main body 51, and an unlock position, which is visible for example in FIG. 3d, in which it gets closer to the rectilinear intermediate portion 51b. Along its relative movement, the safety lock 6 evolves through intermediate positions represented for example in FIGS. 3b and 3c.

With reference to FIG. 1, it can be observed that in the lock position the safety lock 6 is stuck between the main body 51 and the handle 12, so that the movement of the trigger 5 toward the working position is prevented. As instead visible in FIG. 2, in order to activate the trigger 5, the operator must preliminarily reposition the safety lock 6 in the unlock position, that is, bring it close to the main body 51, where it does not interfere with the movement of the latter.

In the embodiment described herein, the rectilinear intermediate portion 51b of the main body 51 has a seat 54 into which the safety lock 6 retracts when it moves to the unlock position. In particular, said seat is defined by a local reduction in the section of the main body 51, wherein the safety lock 6 in the unlock position restores the continuity of the section. The seat 54 also provides, in a section closest to the second hinge axis y, a transverse rib 53, whose opposing lateral faces, which are orthogonal to the second hinge axis y, define a first interference profile 52. The function of said profile will be better explained in the following description. The rib 53 has a thickened upper edge 55 which is visible in FIG. 3c, which, in the guns of the prior art, serves to block the safety lock 6 in the unlock position.

The safety lock 6 develops from a hinged end 65 to a free end 66 and is U-shaped, with two elastically deformable arms 64 connected by a bridge 67 at said free end 66. The two arms 64, which are parallel to each other, have a rectangular section, wherein the bridge 67 develops in a planar manner and connects the opposite faces to the main body 51. An edge 69 of the free end 66 opposite the main body 51, which slides against the handle 11 when the trigger 5 is pressed by the operator, forcing the safety lock 6 to close, is advantageously rounded as visible example in FIG. 3a.

At the hinged end 65, the arms 64 end with two cylindrical appendages, from whose inner faces two opposite pins 62 develop. Said pins 62 are inserted into the opposite ends of a through hole of the main body 51 to allow the safety lock to be hinged thereon.

It should also be underlined that, always at their inner opposite faces, the two arms 64 have tilted ramps that define a second interference profile 61. The tilted ramps are positioned in a section of the arms 64 close to the hinged end 65 and define a local narrowing of an opening 68 defined between said arms 64. The tilted ramps converge toward the direction opposite to that of the main body 51, so that the local narrowing of the opening 68 becomes more pronounced when moving toward the outer face of the safety lock 6. In particular, the ramps are tilted with respect to a plane orthogonal to the second hinge axis y of an angle α comprised between 0.5° and 30°.

As previously said, when brought to the unlock position, the safety lock 6 enters the seat 54 of the main body 51. In this configuration, the rib 53 progressively enters the opening 68. This causes a progressive interference between the first interference profile 52 defined by the lateral faces of the rib 53 and the second interference profile 61 defined by the tilted ramps on the arms 64. The progressive interference of the profiles therefore causes the bending of the two arms 64 and the elastic deformation of the material generates forces that oppose this deformation and tend to bring the safety lock 6 back toward the lock position.

In other words, said arms 64 act as elastic return means 63 in order to bring the safety lock 6 into the lock position when it is not held in another position by the operator's pressure on the trigger 5.

It is also noted that, given the spread of the arms 64 due to the tilted ramps, the upper edge 55 no longer interferes with the perimeter of the opening 68, avoiding that the safety lock 6 gets stuck in the unlock position. It is thus possible to replace the safety lock 6 on guns of the prior art without modifying the main body 51, thus obtaining the dead man's function with extremely low conversion costs.

Obviously, a skilled person may make numerous modifications and variations to the invention described above, in order to satisfy contingent and specific needs, all of which are however included within the scope of protection of the invention as defined by the following claims.

1. A trigger for spray gun comprising a main body, configured to move between a rest position and a working position; a safety lock, hinged on said main body and rotating with respect thereto between a lock position, in which it prevents the movement of the main body from the rest position toward the working position, and an unlock position, in which it allows the movement of the main body toward the working position; and elastic return means configured to define an elastic return action that biases said safety lock toward the lock position, said elastic return means being made integral with said main body and/or with said safety lock.

2. The trigger according to claim 1, wherein said main body and said safety lock comprise a first interference profile and a second interference profile, respectively, said first and second interference profiles progressively interfering with each other during the movement of the safety lock from the lock position to the unlock position so as to elastically deform the elastic return means.

3. The trigger according to claim 2, wherein at least one of said first and said second interference profiles includes a ramp tilted with respect to a plane orthogonal to a hinge axis of the safety lock.

4. The trigger according to claim 3, wherein said elastic return means are made integral with said safety lock, said safety lock (6) develops from a hinged end to a free end and is U-shaped, with two elastically deformable arms connected by a bridge at said free end, said elastic return means comprising at least said arms (64).

5. The trigger according to claim 4, wherein said first interference profile is defined by outer lateral surfaces of a rib of the main body projecting in the direction of the safety lock, said second interference profile being defined by inner lateral surfaces of said arms.

6. The trigger according to claim 5, wherein said second interference profile is defined by ramps tilted with respect to an axis orthogonal to the rotation axis of an angle comprised between 0.5° and 30°.

7. The trigger according to claim 1, wherein the hinging of said safety lock on said main body is made by means of two opposite pins inserted in one or more holes, said pins and said one or more holes being obtained on said arms and on said main body, respectively, or vice versa.

8. The trigger according to claim 1, wherein said safety lock develops from a hinged end to a free end, an edge of said free end opposite the main body being rounded.

9. A spray gun, in particular for high-pressure cleaning and/or hydro-excavation, comprising a body equipped with a handle and a trigger according to claim 1, said trigger being movable between a rest position, in which it closes a liquid supply valve inside the body, and a working position in which it opens said liquid supply valve.

10. A safety lock for trigger of spray gun, configured to hinge on a main body of a spray gun trigger rotatably with respect thereto between a lock position, in which it prevents the movement of said main body from a rest position toward a working position, and an unlock position, in which it allows the movement of the main body toward the working position; said safety lock comprises elastic return means, made integral therewith, configured to define an elastic return action that biases it toward the lock position.
